(19) United States
(12) Patent Application Publication
(10) Pub. No.: US 2010/0099475 A1
(43) Pub. Date: Apr. 22, 2010

(54) PREMIUM GETTING GAME MACHINE AND HUMANOID BIPEDAL WALKING ROBOT

(75) Inventor: Nagasato Soichi, Fukuoka (JP)

Correspondence Address: TUROCY & WATSON, LLP, 127 Public Square, 57th Floor, Key Tower, CLEVELAND, OH, 44114, US

(73) Assignee: ROBO CATCHER PARTNERS CO., LTD., Fukuoka-shi, Fukuoka (JP)

(21) Appl. No.: 12/524,185

(22) PCT Filed: Dec. 11, 2007
(86) PCT No.: PCT/JP2007/073815

§ 371 Date: Jul. 23, 2009

(30) Foreign Application Priority Data
Jan. 23, 2007 (JP) 2007-013185

(51) Int. Cl. A63F 9/24; G06F 19/00

(52) U.S. Cl. 463/7; 700/245

(57) ABSTRACT

The present invention provides a premium getting game machine capable of making a bipedal walking robot (concretely, humanoid bipedal walking robot) whose control is complicated walk for getting a premium. The premium getting game machine 1 makes a humanoid bipedal walking robot 2 walk by an operation of a user to get a premium disposed therein. The premium getting game machine 1 includes a walking-control unit of the humanoid bipedal walking robot 2 in response to the operation of the user, and a holding-control unit which controls the holding action allowing the bipedal walking robot 2 to hold the premium in response to the operation of the user. The premium held by the humanoid bipedal walking robot 2 is dropped into an input opening 15 by the user' s operation of an operation button of an operating unit 19, and the premium is output from an output opening 17.

### TECHNICAL FIELD

The present invention relates to a premium getting game machine and a humanoid bipedal walking robot, and more particularly, to a premium getting game machine for letting a user get a premium and a humanoid bipedal walking robot used for it.

### BACKGROUND ART

As the premium getting game machine, there is a so-called crane game machine, and there is also a game machine using a premium carrying robot which carries a premium as a stream of the premium getting game machine which is derived from the crane game machine (patent document 1).

The inventor filed a patent application for a premium getting game machine using a bipedal walking robot (patent document 2).
Patent Document 1: Japanese Patent Application Laid-open No. 2002-934
Patent Document 2: Japanese Utility Model Registration No. 3131012

### DISCLOSURE OF THE INVENTION

### Problem To Be Solved By the Invention

However, according to a self-propelled robot which is concretely disclosed in the patent document 1, the self-propelling motion such as four-wheel driving operation is precisely controlled, and complicated control such as barycenter control like the bipedal walking robot is beyond the scope of the assumption.

Thus, it is an object of the present invention to provide a premium getting game machine and a humanoid bipedal walking robot used for the premium getting game machine, capable of making a bipedal walking robot (concretely, the humanoid bipedal walking robot) whose control is complicated walk, and capable of getting a premium.

### Means For Solving Problem

A first aspect of the invention provides a premium getting game machine in which a bipedal walking robot is made to walk by operation of a user to get a premium disposed therein, the game machine including walking control means which controls walking action of the bipedal walking robot in response to the operation of the user, and holding action control means which controls holding action to allow the bipedal walking robot to hold the premium in response to the operation of the user.

According to a second aspect of the invention, in the first aspect, the premium getting game machine further includes changing means which changes control action of the walking control means or the holding action control means by the operation of the user into another control action with predetermined probability, wherein a value of the predetermined probability is adjusted to a value which is in response to the operation of the user.

According to a third aspect of the invention, in the first or second aspect, in a space where the bipedal walking robot is made to walk to get a premium disposed in the premium getting game machine, an area into which the bipedal walking robot is prohibited from walking and entering is defined, the premium getting game machine further includes a detection mechanism which detects that the bipedal walking robot enters the area, and a preventing mechanism which prevents the bipedal walking robot from entering in response to detection output of the detection mechanism.

According to a fourth aspect of the invention, in any one of the first to third aspect, the premium getting game machine further includes a transfer mechanism capable of moving a portion of a lower surface of a space where the bipedal walking robot is made to walk to get a premium disposed in the premium getting game machine and transferring the bipedal walking robot.

According to a fifth aspect of the invention, in any one of the first to fourth aspect, the premium getting game machine further includes control means which selects one of a plurality of standing up actions and which makes the bipedal walking robot carry out the selected standing up action when the bipedal walking robot topples over.

According to a sixth aspect of the invention, in any one of the first to fifth aspect, a robot movable area in a space where the bipedal walking robot is made to walk to get the premium disposed in the premium getting game machine is a convex set.

According to a seventh aspect of the invention, in any one of the first to sixth aspect, an input opening from which the bipedal walking robot throws a premium is provided in the space where the bipedal walking robot is made to walk to get the premium disposed therein, a step is provided between the input opening and a surface of the space, and when the bipedal walking robot releases its hand from a premium and lowers an arm, the bipedal walking robot lowers the arm in a space behind the bipedal walking robot and in a space which is in front of the bipedal walking robot and which has a height equal to or higher than a height of the step.

According to an eighth aspect of the invention, in any one of the first to seventh aspect, the premium getting game machine further includes a casing having a space where the bipedal walking robot is made to walk by the operation of the user to get a premium disposed therein, wherein a cable which connects the bipedal walking robot and the casing to each other is located higher than the highest portion of the bipedal walking robot.

A ninth aspect of the invention provides a humanoid bipedal walking robot used for a premium getting game machine for getting a premium disposed therein, wherein a walking action of the humanoid bipedal walking robot, and a holding action capable of holding the premium by an arm of the humanoid bipedal walking robot are controlled in response to an operation of a user, the humanoid bipedal walking robot includes a changing mechanism which changes control action of the walking control means or the holding action control means carried out by the operation of the user to another control action with predetermined probability, and a value of the predetermined probability is a value corresponding to physical influence received by the humanoid bipedal walking robot itself in response to the operation of the user, and the changing mechanism can change and adjust the value.

The above described matters may be recognized as an invention of a control apparatus including control means used for the premium getting game machine, an invention of a control method, an invention of a program for executing the method and an invention of a recording medium in which the program is stored.

Examples of the control actions are control of action for holding a premium (e.g., maintenance of attitude, arm width, direction for getting a premium), and control of action in a state where a premium is held (e.g., maintenance of attitude, holding force of premium, holding direction of premium).

### Effect of the Invention

According to the present invention, by carrying out “walking control of a bipedal walking robot in response to operation of a user” which requires barycenter control and “holding action control for allowing the bipedal walking robot to hold a premium in response to operation of a user”, a premium getting game for making the bipedal walking robot walk by operation of the user to get a premium disposed therein is realized.

### BRIEF DESCRIPTION OF THE DRAWINGS

FIG. 1 is a perspective view of an entire premium getting game machine according to an embodiment of the present invention;

FIG. 2 is a front view of the premium getting game machine shown in FIG. 1;

FIG. 3 is a right side view of the premium getting game machine shown in FIG. 1;

FIG. 4 is a left side view of the premium getting game machine shown in FIG. 1;

FIG. 5 is a plan view of the premium getting game machine shown in FIG. 1;

FIG. 6 is a bottom view of the premium getting game machine shown in FIG. 1;

FIG. 7 is a back view of the premium getting game machine shown in FIG. 1;

FIG. 8 is an enlarged perspective view of an entire humanoid bipedal walking robot used for the premium getting game machine shown in FIG. 1;

FIG. 9 is a front view of the humanoid bipedal walking robot shown in FIG. 8;

FIG. 10 is a right side view of the humanoid bipedal walking robot shown in FIG. 8;

FIG. 11 is a left side view of the humanoid bipedal walking robot shown in FIG. 8;

FIG. 12 is a plan view of the humanoid bipedal walking robot shown in FIG. 8;

FIG. 13 is a bottom view of the humanoid bipedal walking robot shown in FIG. 8;

FIG. 14 is a back view of the humanoid bipedal walking robot shown in FIG. 8;

FIG. 15 is a flowchart for setting a parameter to adjust a probability;

FIG. 16 is a diagram showing another embodiment in which the premium getting game machine shown in FIG. 1 is further improved;

FIG. 17 are diagrams showing modifications of the embodiment shown in FIG. 16;

FIG. 18 is a diagram showing another embodiment in which the premium getting game machine shown in FIG. 1 is further improved;

FIG. 19 is a diagram showing another embodiment in which the premium getting game machine shown in FIG. 1 is further improved;

FIG. 20 are diagrams showing another embodiment in which the premium getting game machine shown in FIG. 1 is further improved;

FIG. 21 are diagrams showing another embodiment in which the premium getting game machine shown in FIG. 1 is further improved;

FIG. 22 are diagrams showing another embodiment in which the premium getting game machine shown in FIG. 1 is further improved;

FIG. 23 are diagrams showing another embodiment in which the premium getting game machine shown in FIG. 1 is further improved;

FIG. 24 is a schematic block diagram of a premium getting game machine 101 showing one example of a premium getting game machine according to an embodiment of the invention.

### EXPLANATION OF SYMBOLS

1 premium getting game machine
2 humanoid bipedal walking robot
101 premium getting game machine
103 casing
107 space
109 bipedal walking robot
115 walking-control unit
117 holding-control unit
119 changing unit
123 detection mechanism
125 preventing mechanism
127 transfer mechanism
129 control unit
131 changing mechanism

### BEST MODE FOR CARRYING OUT THE INVENTION

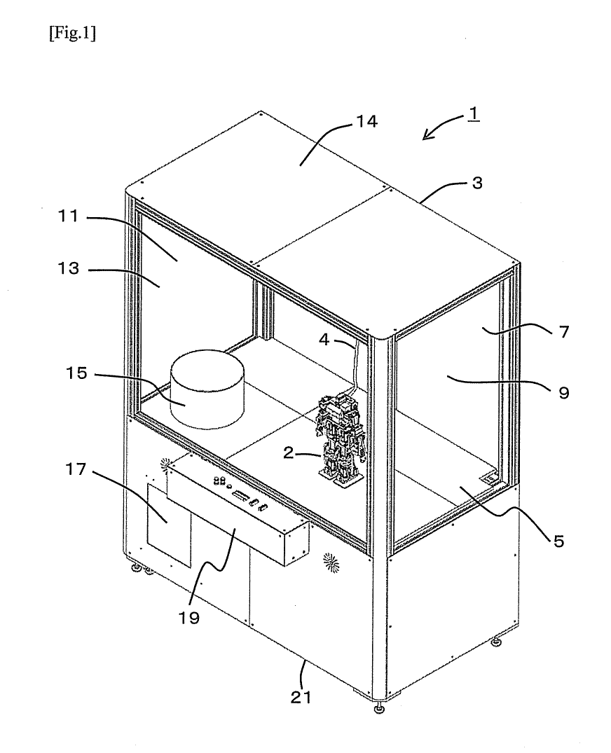

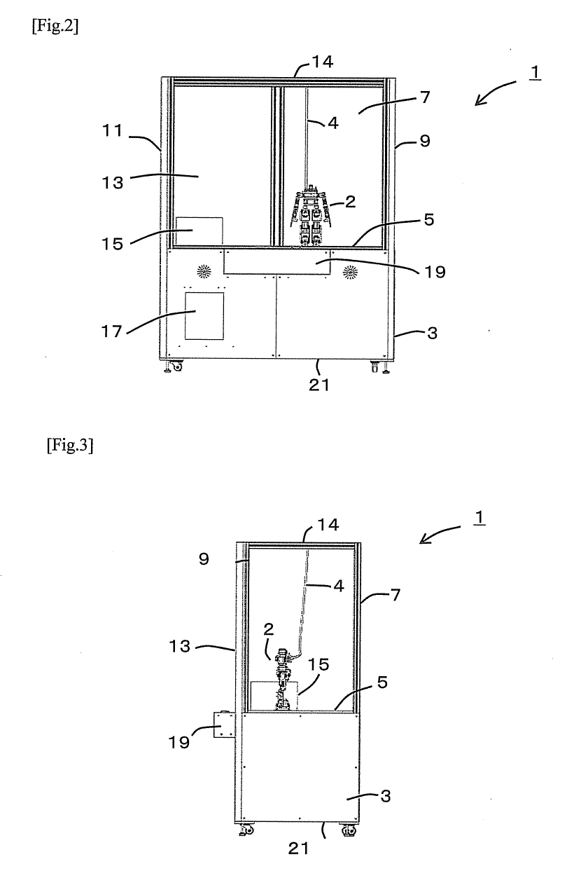

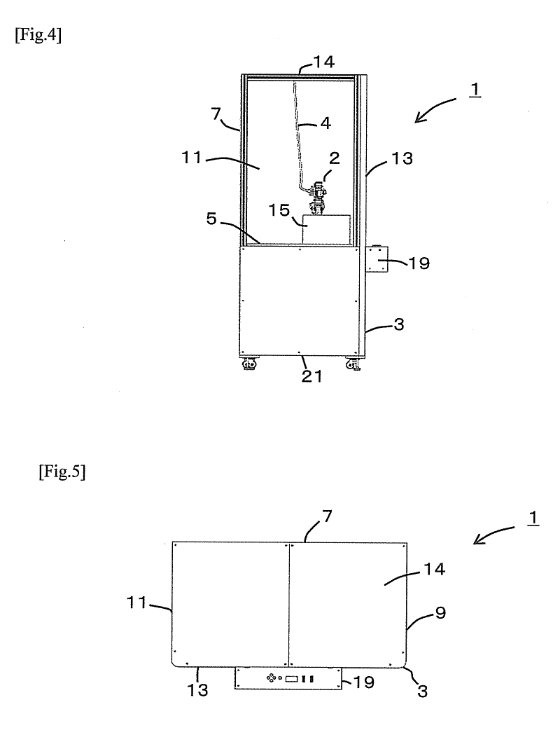

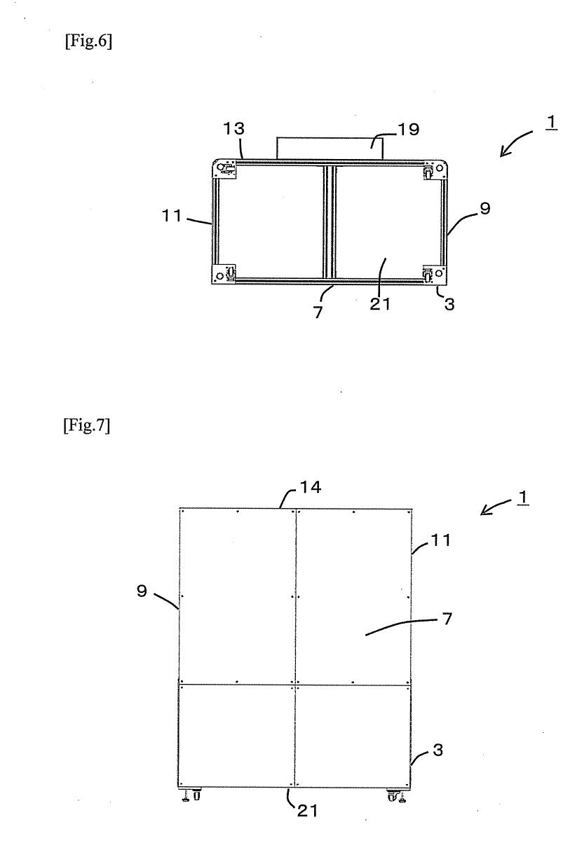

FIG. 1 is a perspective view of an entire premium getting game machine according to an embodiment of the present invention. FIG. 2 is a front view of the premium getting game machine shown in FIG. 1. FIG. 3 is a right side view of the premium getting game machine shown in FIG. 1. FIG. 4 is a left side view of the premium getting game machine shown in FIG. 1. FIG. 5 is a plan view of the premium getting game machine shown in FIG. 1. FIG. 6 is a bottom view of the premium getting game machine shown in FIG. 1. FIG. 7 is a back view of the premium getting game machine shown in FIG. 1.

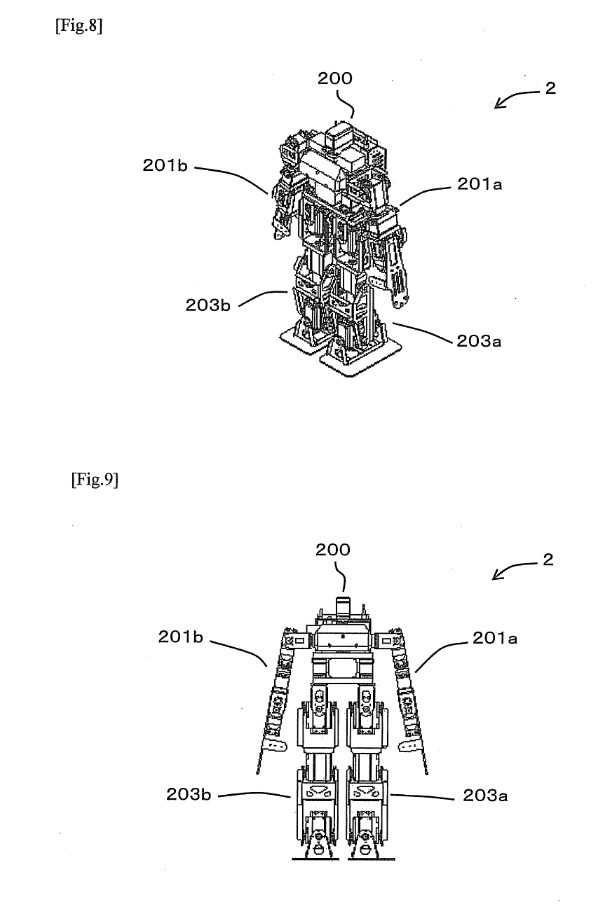

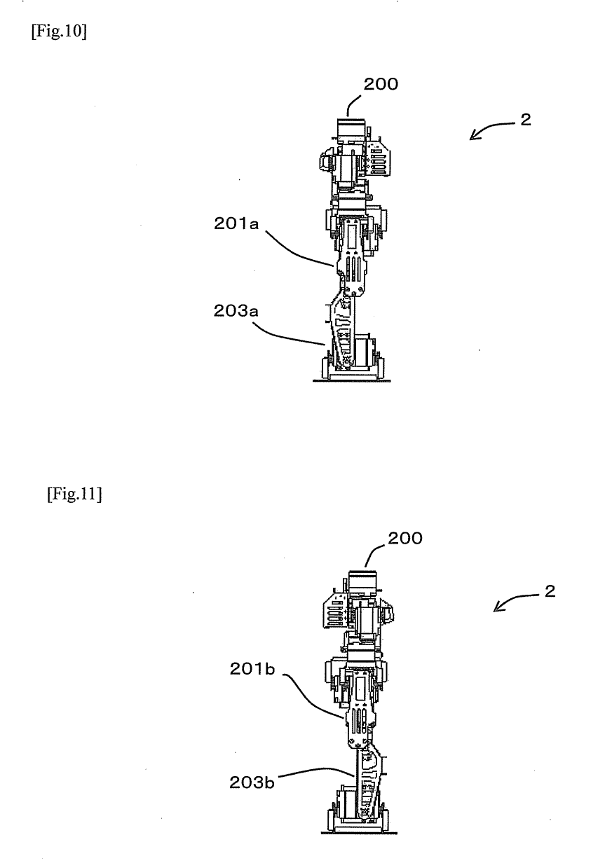

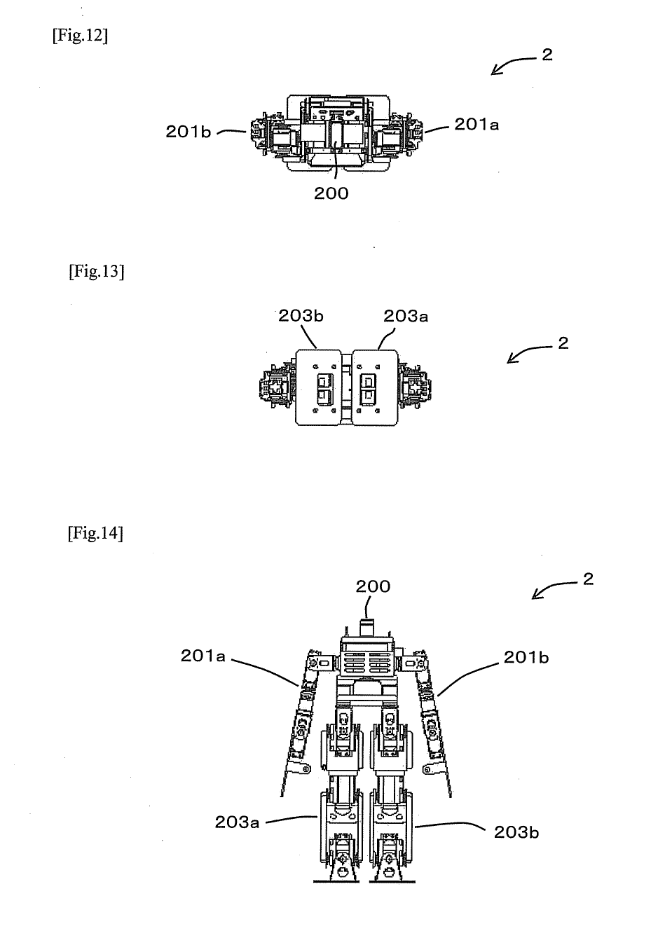

FIG. 8 is an enlarged perspective view of an entire humanoid bipedal walking robot used for the premium getting game machine shown in FIG. 1. FIG. 9 is a front view of the humanoid bipedal walking robot shown in FIG. 8. FIG. 10 is a right side view of the humanoid bipedal walking robot shown in FIG. 8. FIG. 11 is a left side view of the humanoid bipedal walking robot shown in FIG. 8. FIG. 12 is a plan view of the humanoid bipedal walking robot shown in FIG. 8. FIG. 13 is a bottom view of the humanoid bipedal walking robot shown in FIG. 8. FIG. 14 is a back view of the humanoid bipedal walking robot shown in FIG. 8.

Referring to FIGS. 1 to 7, the entire premium getting game machine 1 will be explained below. The premium getting game machine 1 is for getting a premium (not shown) disposed therein by making a humanoid bipedal walking robot 2 walk by a user's operation. The humanoid bipedal walking robot 2 includes a casing 3, and a field space in which the premium is also disposed is formed in the casing 3. The field space is formed of a field plate 5 on which the humanoid bipedal walking robot 2 walks, a back plate 7, clear plates 9, 11 and 13 disposed on front and left and right sides, and a ceiling plate 14. A cable 4 capable of supplying electricity is connected to the humanoid bipedal walking robot 2, and the cable 4 extends toward the ceiling plate 14.

The field plate 5 is formed with an opening through which a premium is dropped. A cylindrical input opening 15 having an opening corresponding to the former opening is formed. The input opening 15 and an output opening 17 from which the premium is taken out are formed in a front side of a lower portion of the casing 3. The input opening 15 is of the cylindrical shape having a height, and this prevents the humanoid bipedal walking robot 2 from falling therefrom and from being carried into the output opening 17.

The casing 3 is provided with an operating unit 19 for carrying out user's operations such as a walking action of the humanoid bipedal walking robot 2, a holding action for picking up a premium, a walking action for making the robot walk while holding the premium, and a throwing action for dropping the held premium into the input opening 15. The operating unit 19 is provided with operation buttons and a coin input opening. A control signal is sent to the humanoid bipedal walking robot 2 through the cable or through radio communication when the operating unit 19 is operated by a user.

Here, all of actions that can be operated need not be explained for users, and actions that can not be expected by a user may be carried out by predetermined operation other than operations that are not explained like so-called “hidden commands”.

The lowermost surface of the casing 3 is provided with a bottom plate 21 as shown in FIG. 6, and the bottom is closed.

Referring to FIGS. 8 to 14, a general outline of the humanoid bipedal walking robot 2 will be explained briefly. The humanoid bipedal walking robot 2 includes a head 200, arms 201a and 201b and legs 203a and 203b. The legs 203a and 203b are used for walking, and the arms 201a and 201b are used for holding a premium. The legs 203a and 203b are used for walking action of the humanoid bipedal walking robot 2, the arms 201a and 201b are used for picking up and holding a premium, the legs 203a and 203b are used for walking action in a state where the premium is held, and the arms 201a and 201b are used for dropping the held premium into the input opening 15.

The control of actions is carried out by a walking-control unit and a holding-control unit in a control apparatus (not shown) in the casing 3. The holding-control unit can also control the holding-releasing action

In the control of the actions, operation of an operator may be sent to the humanoid bipedal walking robot 2 as a control signal as it is, or the control action may not be established at a predetermined probability in response to operation of the operator to previously adjust a difficulty level of operation, and the actions may be changed to other actions. More specifically, as an example, to make it easy to generate an influence of a physical external force to the robot itself by walking action while holding a premium, weights may be added to predetermined locations of the arms 201a and 201b or the legs 203a and 203b.

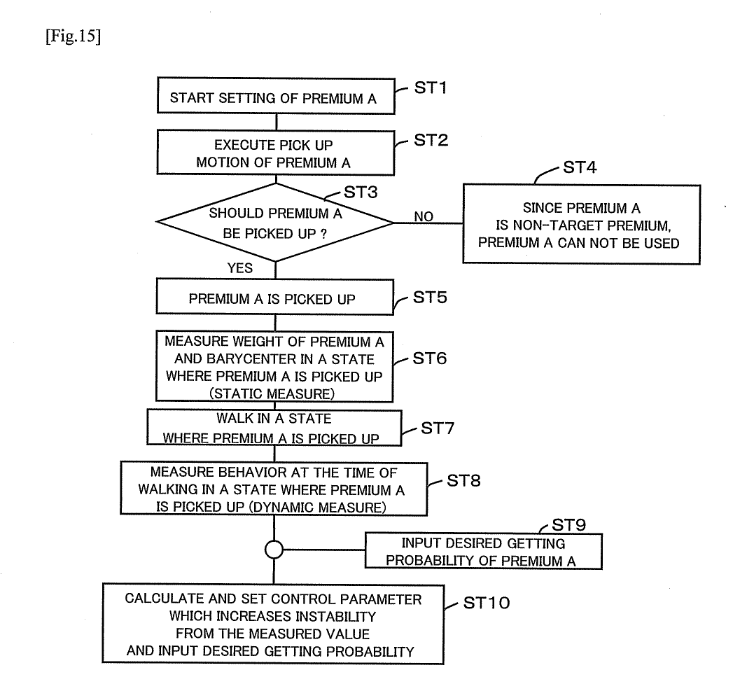

Parameters maybe set by a program for the probability as shown in FIG. 15.

FIG. 15 is a flowchart for setting the parameters to adjust the probability. The processing in the flow are setting and maintenance modes which are different from normal game mode.

In step ST1, a premium A is set as a subject of the probability, and the setting operation is started. To execute the control action, in step ST2, motion for picking up the premium A by the humanoid bipedal walking robot 2 is executed. In step ST3, it is determined whether the premium A should be picked up. If it is failed, it is determined in step ST4 that the premium A can not be used as a subject product used for this game in terms of volume, weight or the like. In the case of success, in step ST5, since the premium A is picked up, processing in steps ST5 to ST8 is further carried out. In step ST6, weight of the premium A, a barycenter in the picked up state are measured (static measurement). In step ST7, walking action in a state where the premium A is picked up is carried out. In step ST8, behavior at the time of walking while picking up the premium A is measured (dynamic measurement). In the static measurement, a torque of a meter when the premium is picked up is measured. In the dynamic measurement, data of a gyro sensor is measured. Results of these measurements and a desired getting probability of a premium A which is input in step ST9 are used, and a control parameter which increases instability in control of walking is calculated and set in step ST10.

If an action after the change has a high toppling probability, since the humanoid bipedal walking robot 2 previously grasps that the action is changed, it is possible to stand on the defensive. Here, it is preferable that the defensive action reduces impact on the robot at the time of toppling. Apart from giving a higher priority to the moderation of impact, it is also possible to overact to appeal the performance at the time of toppling to the operator or audience. Anything existing in the field space may be used for the defensive action, and examples of the defensive action are touching the back plate 7 with the hand, and touching with the hand and somersault as overaction. In the case of touching the back plate 7 with the hand, it is necessary to grasp the position of the back plate 7, and a technique which is taken into consideration including this fact will be described later.

Other than adjustment of a premium getting probability by a stable gyro, it is possible to adjust the premium getting probability by changing a width of the arm, a grasping force of a premium, a grasping direction of a premium, a holding force of a premium, and a holding direction of a premium.

Performance may be controlled other than the above-described control. That is, according to the premium getting game machine 1 using the humanoid bipedal walking robot 2, a user operates the humanoid bipedal walking robot 2 to pick up a premium, moves the premium to the input opening 15 in the casing 3, and if the throwing of the premium into the input opening 15 is successful, the user can get the premium. An optical sensor or the like disposed at the input opening of a premium senses and determines whether the premium is thrown successfully or not, if the premium is thrown successfully, robot performance expressing pleasure of success such as dancing may automatically be carried out, and if the premium is thrown in failure, failure performance such as slapping on a floor with vexation may automatically be carried out. After such performance is carried out, determination whether the game is continued or not is made in accordance with a game system such as remaining time and point, and if YES, the game may be continued, and if NO, the game may be finished.

When a user does not play the game, the humanoid bipedal walking robot 2 is brought into a standby state, but to appeal to customers, standby-performance may automatically be carried out by sensing that predetermined standby time is elapsed or a person approaches the premium getting game machine 1. As the standby-performance, performance in which characteristics of the humanoid bipedal walking robot 2 are capitalized on such as dancing or action that induces the customers to play the game is set. A series of the set actions may not only be executed, premiums scattered in the casing 3 may automatically be discriminated by an optical sensor or the like, and the premiums may be disposed (cleaned) to a predetermined position. By this cleaning action, it is possible to appeal the stable action of the humanoid bipedal walking robot 2 to customers, and to induce the customers to play the game or to start the game before premiums which are scattered are relocated to difficult positions (positions away from the input opening).

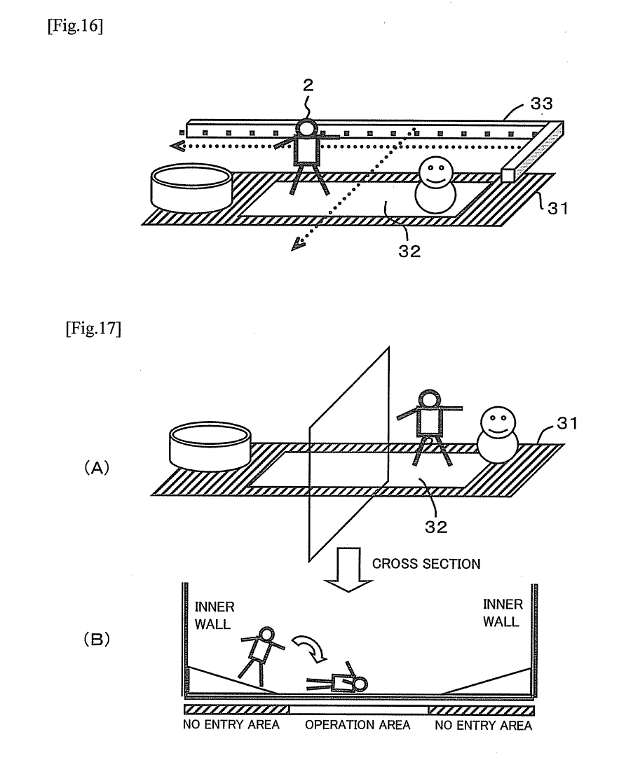

FIG. 16 is a diagram showing another embodiment in which the premium getting game machine shown in FIG. 1 is further improved.

A device made here is control of action of a robot for preventing the robot from entering into a robot no entry area 31. When the humanoid bipedal walking robot 2 used in the premium getting game machine 1 has a function for automatically standing up at the time of toppling, a flat and sufficient space for touching with a hand is required for carrying out the stand up action. In the premium getting game machine 1, the humanoid bipedal walking robot 2 is operated in the field space in the casing 3, and a sufficient space for standing up action can not be secured depending upon a state at the time of toppling such as contact with an inner wall in some cases. To prevent this, an area where a space for standing up action can not be secure is previously defined as the robot no entry area 31, and an area where the robot can be operated is defined as a robot operation area 32. To prevent the robot from entering into the robot no entry area 31, a sensor unit 33 such as an optical sensor is disposed in the field space. With this, a scan line such as a laser as shown with an arrow shown with a broken line in FIG. 16 appears, a position of the humanoid bipedal walking robot 2 in the casing 3 is grasped and as a result, it is possible to prohibit the entering action into the robot no entry area 31.

FIG. 17 shows a modification of the embodiment shown in FIG. 16. A sectional view of FIG. 17(A) is shown in FIG. 17(B).

Here, opposite sides of a floor of the robot no entry area 31 are reversely sloped so that the robot inevitably topples over toward the flat robot operation area 32.

If the invention shown in FIGS. 16 and 17 is summarized, the premium getting game includes the humanoid bipedal walking robot, an operating unit used by a user to operate the humanoid bipedal walking robot, and a casing having a space in which the humanoid bipedal walking robot is made to walk by the user's operation to get a premium disposed therein, an area where the humanoid bipedal walking robot is prohibited from walking and entering is defined in the space, the premium getting game further includes a detection mechanism which detects that the humanoid bipedal walking robot enters the area, and a preventing mechanism which prevents the humanoid bipedal walking robot from entering in response to the detection output of the detection mechanism.

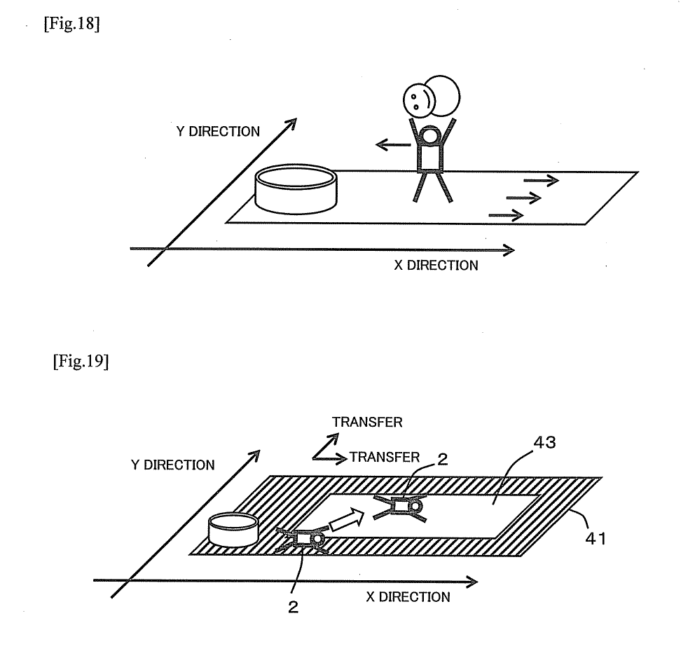

FIG. 18 shows another embodiment in which the premium getting game machine shown in FIG. 1 is further improved.

The improvement here is enhancement of a degree of play or game by moving the floor in the field space in XY direction. To enhance the degree of play or game, the floor in the casing 3 where the humanoid bipedal walking robot 2 is operated can be moved in the XY direction. In FIG. 18, by moving the floor in the X direction, the humanoid bipedal walking robot 2 is moved away from the input opening. Therefore, the difficulty level of throwing is increased and the degree of play or game is increased. The same effect can be expected by moving the floor in the Y direction.

If the invention shown in FIG. 18 is summarized, the premium getting game includes the humanoid bipedal walking robot, an operating unit used by a user to operate the humanoid bipedal walking robot, a casing having a space in which the humanoid bipedal walking robot is made to walk by the user's operation to get a premium disposed therein, and a transfer mechanism in which a portion of a lower surface of the space moves and the humanoid bipedal walking robot can be transferred.

FIG. 19 is a diagram showing another embodiment in which the premium getting game machine shown in FIG. 1 is further improved.

Here, automatic standing up action at the time of toppling is assisted by operation of the floor of the field space in the XY direction. As described in the explanation of the robot no entry area 31 shown in FIGS. 16 and 17, a flat sufficient space for touching action of hands is required to execute the automatic standing up action at the time of toppling. However, a sufficient space for standing up action can not be secured in some cases depending upon a state at the time of toppling such as contact with the inner wall. In this case, a position of the robot is grasped by the optical sensor shown in FIG. 16, and if the robot topples over in a robot automatically-standing up impossible area 41, the floor is moved in the XY direction like the case shown in FIG. 18, the humanoid bipedal walking robot 2 is transferred to a robot automatically-standing up possible area 43, and the standing up action is executed.

If the invention shown in FIG. 19 is summarized, the premium getting game includes the humanoid bipedal walking robot, an operating unit used by a user to operate the humanoid bipedal walking robot, a casing having a space in which the humanoid bipedal walking robot is made to walk by the user's operation to get a premium disposed therein, an area where the humanoid bipedal walking robot is prohibited from walking and entering is defined in the space, the premium getting game further includes a detection mechanism which detects whether the humanoid bipedal walking robot enters this area or not, and a transfer mechanism capable of moving a portion of a lower surface of the space in response to detection output of the detection mechanism and capable of transferring the humanoid bipedal walking robot.

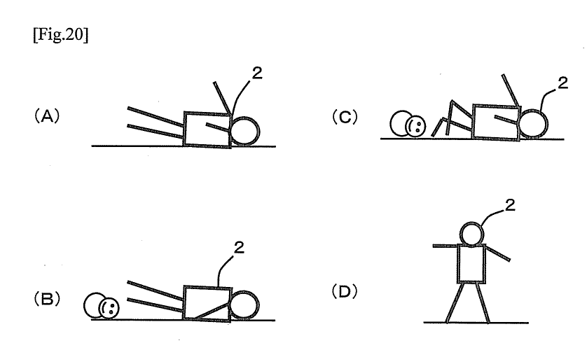

FIG. 20 are diagrams showing another embodiment in which the premium getting game machine shown in FIG. 1 is further improved.

This embodiment is characterized by an execution method of the automatic standing up action of the humanoid bipedal walking robot 2. FIG. 20(A) shows that the humanoid bipedal walking robot 2 topples over. When there is only one automatic standing up method, if the robot rides a premium or the like as shown in FIG. 20(B), even if the standing up action is carried out, the premium exists under the robot and thus the robot topples over, and the same standing up action must be repeated many times in some cases. To prevent this, if a predetermined standing up action is repeated a plurality of times, the humanoid bipedal walking robot 2 recognizes this fact, another standing up action (e.g., standing up while avoiding a premium existing under the leg, or moving to another place and standing up as shown in FIG. 20(C)) is carried out, thereby avoiding the premium existing under the humanoid bipedal walking robot and the robot can stand up (see FIG. 20(D)).

If the invention shown in FIG. 20 is summarized, the premium getting game includes the humanoid bipedal walking robot, an operating unit used by a user to operate the humanoid bipedal walking robot, a casing having a space in which the humanoid bipedal walking robot is made to walk by the user's operation to get a premium disposed therein, and control means which selects one of a plurality of standing up actions and carries out the same for the humanoid bipedal walking robot when it topples over.

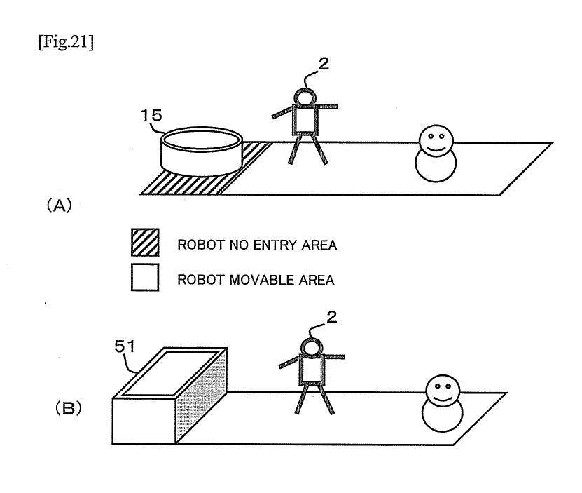

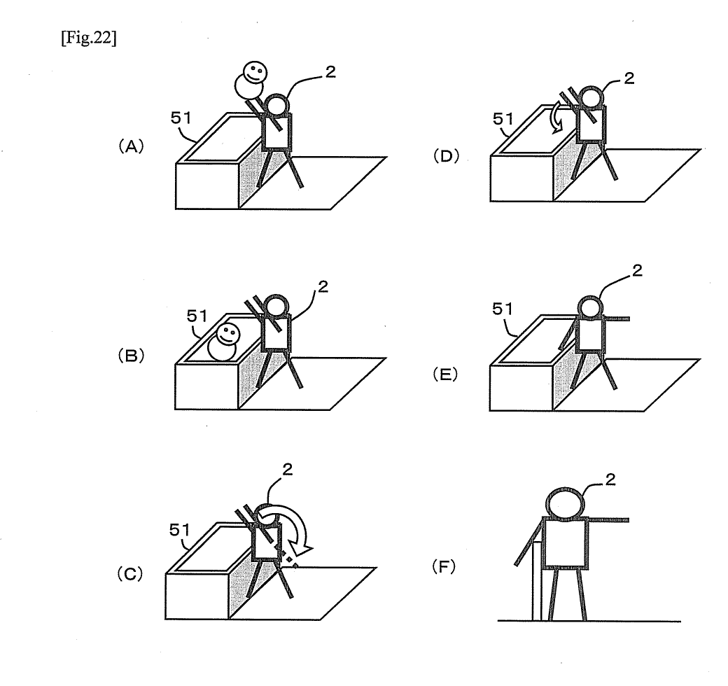

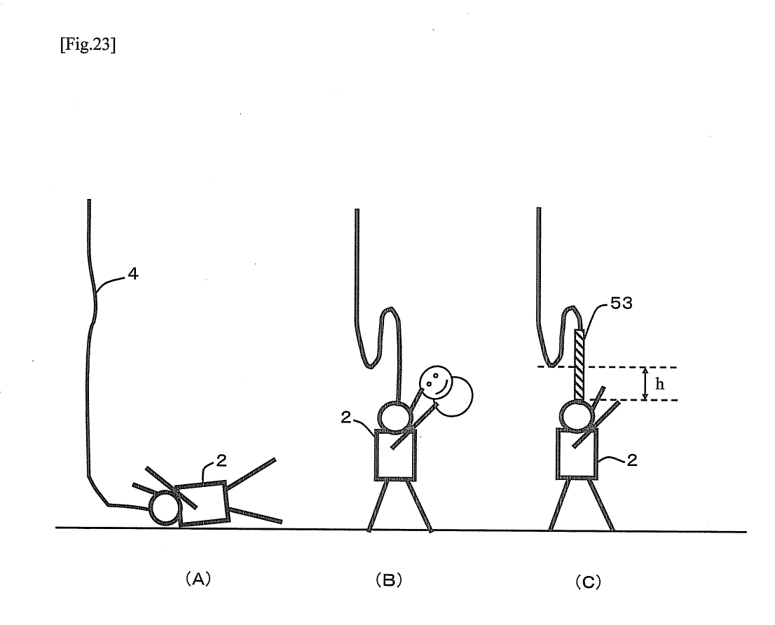

FIG. 21 are diagrams showing another embodiment in which the premium getting game machine shown in FIG. 1 is further improved.

This embodiment is characterized by a movable area of the robot. When the input opening of premium is of the cylindrical shape as shown in FIG. 21(A), interference with a wall surface when the humanoid bipedal walking robot 2 goes behind the input opening becomes a problem. Thus, it is necessary to define a robot no entry area or the like and performs control such that the robot does not enter the area. Hence, the input opening of premium is formed into a rectangular shape so that the humanoid bipedal walking robot 2 can not physically go behind the input opening. If the opening is formed on the field plate 5 such that the field plate 5 except the opening becomes a projecting polygonal shape, it is possible to prevent the humanoid bipedal walking robot 2 from going behind the input opening, and to eliminate the robot no entry area.

If the invention shown in FIG. 21 is summarized, the premium getting game includes the humanoid bipedal walking robot, an operating unit used by a user to operate the humanoid bipedal walking robot, and a casing having a space in which the humanoid bipedal walking robot is made to walk by the user's operation to get a premium disposed therein, and an area where the humanoid bipedal walking robot can move in the space is a convex set (with respect to a subset in the space, the shortest line segment connecting arbitrary two points in the subset is included in the subset)

FIG. 22 are diagrams showing another embodiment in which the premium getting game machine shown in FIG. 1 is further improved.

This embodiment is characterized by an action of the humanoid bipedal walking robot 2 after a premium is thrown. The premium input opening is provided with a wall surface which becomes a step to a certain extent (step of such a height that the humanoid bipedal walking robot 2 can throw a premium into the input opening but the humanoid bipedal walking robot 2 will not drop into the input opening when the humanoid bipedal walking robot 2 gets close to the input opening) to prevent the humanoid bipedal walking robot 2 from dropping and from being carried to the output opening 17. When the humanoid bipedal walking robot 2 picks up a premium, approaches the premium input opening (FIG. 22(A)), releases its hand from the premium (FIG. 22(B)), and lowers the brought-up arm, the humanoid bipedal walking robot 2 does not lower the arm as it is but turns the arm from behind and lowers the arm as shown in FIG. 22(C) for example. As shown in FIG. 22(D), if the brought-up arm is lowered as it is, a wall surface of the premium input opening is sandwiched by an armpit of the robot as shown in FIG. 22(E) and FIG. 22(F) showing its sectional view, and the robot is brought into a restoration-impossible state. As shown in FIG. 22(C), the humanoid bipedal walking robot 2 operates at a level equal to or higher than a wall surface of the premium input opening in the space on the side of the input opening. With this, it is possible to prevent the robot from sandwiching the wall surface of the premium input opening by the armpit as shown in FIGS. 22(E) and (F).

If the invention shown in FIG. 22 is summarized, the premium getting game includes the humanoid bipedal walking robot, an operating unit used by a user to operate the humanoid bipedal walking robot, and a casing having a space in which the humanoid bipedal walking robot is made to walk by the user's operation to get a premium disposed therein, the space is provided with an input opening from which the humanoid bipedal walking robot throws a premium, a step is provided between the input opening and the movable area of the humanoid bipedal walking robot, and when the bipedal walking robot releases its hand from a premium and lowers the arm, the robot lowers the arm in a rearward space and in a forward space having a height equal to or higher than the step.

FIG. 23 are diagrams showing another embodiment in which the premium getting game machine shown in FIG. 1 is further improved.

This embodiment is characterized by the cable 4 shown in FIG. 1. It is necessary that the cable 4 is connected to the humanoid bipedal walking robot 2 even at the time of toppling (see FIG. 23(A)). Therefore, it is necessary that the length of the cable 4 is almost equal to lengths of a floor plate and a ceiling. Thus, when the robot is normally operated (when the robot walks with two legs), there is an adverse possibility that the cable 4 is redundant and loosened and the cable interferes with the arm of the robot or the like (see FIG. 23(B)). To avoid this, as shown in FIG. 23(C), the cable is brought upward in the vertical direction of the robot by a cable standing up part 51 so that a distance h between the lowest portion of a cable slack and the highest portion of the robot body always becomes 0 or greater.

A member that is different from the cable 4 such as the cable standing up part 51 may not be used. For example, a portion of the cable 4 closer to a robot connecting portion than the ceiling may be brought into a hard state, and the cable slack lowest portion may be set higher than the robot body highest portion. Tension applied to the cable from the ceiling or robot may be controlled to optimize the slack of the cable. In such a case, it is necessary to pull the cable under such a tension that walking or toppling of the robot is not influenced.

A rotary connector which is a rotatable connector may be used for connecting the cable 4 and the ceiling. With this, twisting of the cable 4 can be prevented.

If the invention shown in FIG. 23 is summarized, the premium getting game includes the humanoid bipedal walking robot, an operating unit used by a user to operate the humanoid bipedal walking robot, and a casing having a space in which the humanoid bipedal walking robot is made to walk by the user's operation to get a premium disposed therein, and a cable which connects the humanoid bipedal walking robot and the casing to each other is located higher than the highest portion of the humanoid bipedal walking robot.

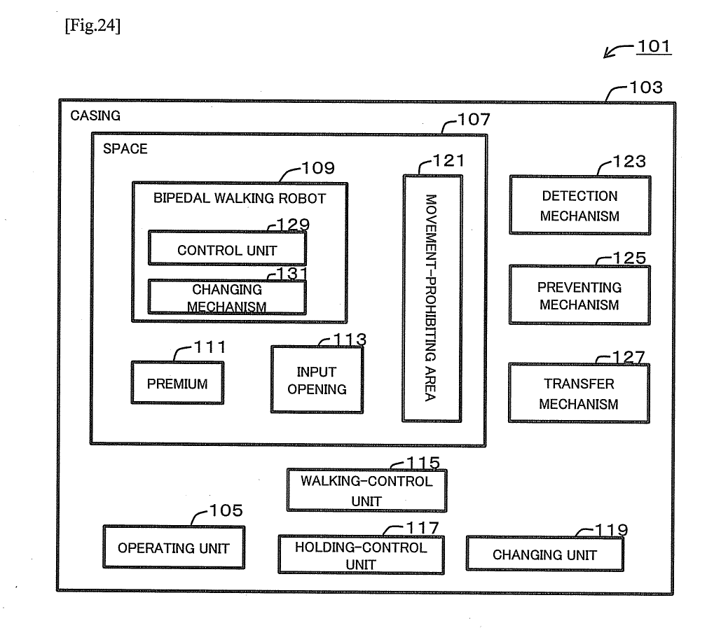

FIG. 24 is a schematic block diagram of a premium getting game machine 101 showing one example of a premium getting game machine according to an embodiment of the invention. The premium getting game machine 101 includes a casing 103. The casing 103 includes an operating unit 105 operated by a user. A user operates the operating unit 105 to make a bipedal walking robot 109 walk in a space 107, moves a premium 111 disposed in the same space 107 to an input opening 113, and makes the user get the premium 111.

The casing 103 includes a walking-control unit 115 which controls the walking action of the bipedal walking robot 109 in response to the user's operation, and a holding-control unit 117 which controls the holding action for making the bipedal walking robot hold the premium 111 in response to the user's operation.

The casing 103 includes a changing unit 119 which changes the control action of the walking-control unit 115 or the holding-control unit 117 by the user's operation to a different control action with a predetermined probability. The value of this predetermined probability is adjusted to a value which is in response to the operation of the user.

As shown in FIGS. 16 and 17, a movement-prohibiting area 121 into which the bipedal walking robot 109 is prohibited from walking and entering may be defined in the space 107. In this case, the casing 103 includes a detection mechanism 123 which detects that the bipedal walking robot 109 enters the movement-prohibiting area 121, and a preventing mechanism 125 which prevents the bipedal walking robot 109 from entering in response to the detection output of the detection mechanism 123.

As shown in FIGS. 18 and 19, the casing 103 may include a transfer mechanism 127 capable of moving a portion of the lower surface of the space 107 and transferring the bipedal walking robot 109.

The bipedal walking robot 109 may include a control unit 129, and when the bipedal walking robot 109 topples over, the control unit 129 may select one of a plurality of standing up actions and making the bipedal walking robot carry out the selected standing up action as shown in FIG. 20.

In the space 107, the area where the bipedal walking robot 109 can move may be a convex set. In this case, as shown in FIG. 21, the movement-prohibiting area 121 may not be provided depending upon shapes of the space 107 and the input opening 113.

As shown in FIG. 22, when the bipedal walking robot 109 releases its hand from a premium and lowers the arm, the bipedal walking robot 109 may carry out such motion in a space behind the robot or in a space in front of the robot at a height higher than the input opening 113.

As shown in FIG. 23, the cable which connects the casing 103 and the bipedal walking robot 109 to each other may be located at a position higher than the highest portion of the bipedal walking robot 109.

The bipedal walking robot 109 may include a changing mechanism 131. A weight is mounted on the changing mechanism 131 to change the stability, thereby adjusting premium getting probability.

The block diagram in FIG. 24 shows one example of the premium getting game machine. For example, the walking-control unit 115 may be provided in the bipedal walking robot 109, or control units respectively provided in the casing 103 and the bipedal walking robot 109 may cooperatively operate to realize the walking-control unit 115. The same can be applied to the holding-control unit 117, the changing unit 119 and the control unit 129.

1.-9. (canceled)

10. A premium getting game machine in which a bipedal walking robot is made to walk by operation of a user to get a premium disposed therein, comprising
walking control means which controls walking action of the bipedal walking robot in response to the operation of the user, and
holding action control means which controls holding action to allow the bipedal walking robot to hold the premium in response to the operation of the user.

11. The premium getting game machine according to claim 10, further comprising changing means which changes control action of the walking control means or the holding action control means by the operation of the user into another control action with predetermined probability, wherein
a value of the predetermined probability is adjusted to a value which is in response to the operation of the user.

12. The premium getting game machine according to claim 10, wherein in a space where the bipedal walking robot is made to walk to get a premium disposed in the premium getting game machine, an area into which the bipedal walking robot is prohibited from walking and entering is defined, the premium getting game machine further comprises
a detection mechanism which detects that the bipedal walking robot enters the area, and
a preventing mechanism which prevents the bipedal walking robot from entering in response to detection output of the detection mechanism.

13. The premium getting game machine according to claim 10, further comprising a transfer mechanism capable of moving a portion of a lower surface of a space where the bipedal walking robot is made to walk to get a premium disposed in the premium getting game machine and transferring the bipedal walking robot.

14. The premium getting game machine according to claim 10, further comprising control means which selects one of a plurality of standing up actions and which makes the bipedal walking robot carry out the selected standing up action when the bipedal walking robot topples over.

15. The premium getting game machine according to claim 10, wherein a robot movable area in a space where the bipedal walking robot is made to walk to get the premium disposed in the premium getting game machine is a convex set.

16. The premium getting game machine according to claim 10, wherein an input opening from which the bipedal walking robot throws a premium is provided in a space where the bipedal walking robot is made to walk to get the premium disposed therein,
a step is provided between the input opening and a surface of the space, and
when the bipedal walking robot releases its hand from a premium and lowers an arm, the bipedal walking robot lowers the arm in a space behind the bipedal walking robot and in a space which is in front of the bipedal walking robot and which has a height equal to or higher than a height of the step.

17. The premium getting game machine according to claim 10, further comprising a casing having a space where the bipedal walking robot is made to walk by the operation of the user to get a premium disposed therein, wherein
a cable which connects the bipedal walking robot and the casing to each other is located higher than the highest portion of the bipedal walking robot.

18. A humanoid bipedal walking robot used for a premium getting game machine for getting a premium disposed therein, wherein
a walking action of the humanoid bipedal walking robot, and a holding action capable of holding the premium by an arm of the humanoid bipedal walking robot are controlled in response to an operation of a user,
the humanoid bipedal walking robot includes a changing mechanism which changes control action of the walking control means or the holding action control means carried out by the operation of the user to another control action with predetermined probability, and
a value of the predetermined probability is a value corresponding to physical influence received by the bipedal walking robot itself in response to the operation of the user, and the changing mechanism can change and adjust the value.
